(19) United States
(12) Patent Application Publication
(10) Pub. No.: US 2005/0025273 A1
(43) Pub. Date: Feb. 3, 2005

(54) Method and apparatus for echo compensation

(76) Inventor: Wolfgang Tschirk, Wien (AT)

Correspondence Address: Dicke, Billig & Czaja, PLLC, Fifth Street Towers, Suite 2250, 100 South Fifth Street, Minneapolis, MN, 55402, US

(21) Appl. No.: 10/872,352

(22) Filed: Jun. 17, 2004

(30) Foreign Application Priority Data
Jun. 27, 2003 (DE) 103 29 055.9

(51) Int. Cl. H04B 1/10

(52) U.S. Cl. 375/350

(57) ABSTRACT

To compensate the echo contained in an echo-affected received signal it is proposed to generate a compensation signal with the aid of adaptive filter means, which compensation signal is subtracted from the echo-affected received signal. The adaptive filter means are adapted in dependence on a correlation between the echo-affected received signal and the compensation signal. By the insertion of an additional virtual echo path defined adaptation behavior can be ensured even in the case of small signals.

### CROSS-REFERENCE TO RELATED APPLICATIONS

This Utility Patent Application claims priority to German Patent Application No. DE 103 29 055.9, filed on Jun. 27, 2003, which is incorporated herein by reference.

### BACKGROUND

The present invention relates to a method and an apparatus for echo compensation. In particular, the invention relates to a method and an apparatus for echo compensation in which a compensation signal for an echo-affected received signal is generated with the aid of adaptive filter means to compensate or eliminate the echo contained in the echo-affected received signal.

In combined transmitting and receiving devices of various types, e.g. full duplex hands-free devices or transceiver arrangements, the problem can arise that a signal received by the transmitting and receiving device, referred to hereinafter as the received signal, has superimposed thereon a component of a signal simultaneously transmitted by the transmitting and receiving device, referred to hereinafter as the transmitted signal, and is thereby distorted. This component coupled into the transmitted signal is referred to as an echo, because it is transmitted back via the actual received signal of the transmitting and receiving device.

An echo makes evaluation of the received signal affected thereby fundamentally more difficult. Consequently, it is necessary to process the received signal affected by the echo in such a way that the echo in the echo-affected received signal is compensated for or eliminated.

Echoes are frequently compensated for in known fashion by means of adaptive filters. The characteristic of such an adaptive filter is approximated by an iterative (adaptive) procedure to that of the actual echo path via which the echo is coupled from the transmitted signal path into the received signal path, even when the echo path changes in time, so that a compensation signal similar to the echo is generated from the transmitted signal in question by the adaptive filter, which is coupled to the transmitted signal path on the input side. The compensation signal is then subtracted from the echo-affected received signal in order to obtain the pure received signal.

However, echo compensation by means of adaptive filters can be disturbed if the echo is not present in pure form but has a superimposed additional signal component, such as, in particular, speech or other noises. In the case of this phenomenon, known as “doubletalk”, adaptation is more unreliable the higher the level of this additional signal component in relation to the echo level.

To solve this problem, echo compensators are frequently equipped with a so-called “doubletalk control”. This is a device that detects such an adaptation-disturbing signal component in order then to influence adaptation in dependence on the level of this signal component. Thus, when there is strong interference in the echo, adaptation takes place only slightly or not at all.

However, the signal that disturbs adaptation is not present in pure form and therefore can be determined only approximately. In addition, it manifests itself in the same way as a change in the echo path, in which case adaptation must take place very rapidly. Confusion of the adaptation-disturbing signal with an echo path change therefore initiates the precise opposite of the desired adaptation behavior.

To avoid exact determination of the signal that disturbs adaptation, various correlation-based “doubletalk” detection algorithms have been proposed. For example, it has been proposed to perform the adaptation of the adaptive filter in dependence on the correlation between the transmitted signal and the received signal recovered by subtraction of the compensation signal from the echo-affected received signal. It has also been proposed to adapt the adaptive filter in dependence on the correlation between the transmitted signal and the echo-affected received signal. However, because of the unknown echo delay, both approaches require a very large number of correlation coefficients to be estimated, which calls for a correspondingly high calculation outlay. In addition, both approaches are dependent on suitably selected threshold values for making the necessary decisions to adjust the adaptive filter, which is intrinsically critical in applications in real practice.

### SUMMARY

In one embodiment of the present invention, a method and an apparatus are specified for echo compensation by which a compensation signal corresponding as precisely as possible to the echo in an echo-affected received signal can be generated with low complexity and cost, in order to compensate the echo in the echo-affected received signal with the aid of the compensation signal and thus to obtain the pure received signal.

According to one embodiment of the invention, an echo in an echo-affected received signal is compensated with the aid of adaptive filter means.

The adaptive filter means is generated from a transmitted signal that produces the echo a compensation signal, which is to a large extent an exact simulation of the echo and which can therefore eliminate the echo contained in the echo-affected received signal by subtraction therefrom.

The adaptation, that is, the adjustment of the adaptive filter means, is carried out in dependence on the correlation between the echo-affected received signal and the compensation signal.

With the solution according to one embodiment of the invention, an explicit determination of a signal component that may possibly be disturbing the adaptation, such as speech or other noises in the echo-affected received signal, is not required, and the adaptation behaves correctly according to the particular situation obtaining, that is, the adaptation is slowed down in the case of interference whereas it is speeded up in the case of a change in the echo path.

Through the introduction of a virtual echo path, random adaptations at very low signal levels can be avoided. This virtual echo path may include FIR (“Finite Impulse Response”) filter means having constant coefficients, the length of these filter means of the virtual echo path corresponding at most to that of the adaptive filter means. Before adaptation, the coefficients of the adaptive filter means may advantageously be initialized, not with “0” but with the coefficients of the virtual echo path, in order to start the adaptation with a system error that is not impaired by the virtual echo generated by the virtual echo path.

In one embodiment, adaptation takes place in dependence on the correlation between a combination signal, which is obtained by combination, in particular addition, of the echo-affected received signal and the virtual echo signal generated by the virtual echo path, and the compensation signal of the adaptive filter means.

Unlike other “doubletalk” algorithms, one embodiment of the invention requires only small calculation outlay, is not dependent on threshold values and, in addition, is numerically insensitive. The last-mentioned property is advantageous, in particular, for implementations in “fixed point” processors. In addition, the invention can be used simply as an extension of conventional adaptation algorithms.

One embodiment of the invention is suitable for use in all transmitting and receiving devices. In particular, one embodiment of the invention can be used for acoustic echo compensation, for example, with full duplex hands-free devices.

In one embodiment, the invention can be used both for full-band and for sub-band echo compensation. It is possible in the latter case to apply the invention individually to each individual frequency band in order to determine band-specific step size factors. However, in the last-mentioned case the invention can also be applied to the total signal concerned in order to determine a common step size factor for all frequency bands.

### BRIEF DESCRIPTION OF THE DRAWINGS

The accompanying drawings are included to provide a further understanding of the present invention and are incorporated in and constitute a part of this specification. The drawings illustrate the embodiments of the present invention and together with the description serve to explain the principles of the invention. Other embodiments of the present invention and many of the intended advantages of the present invention will be readily appreciated, as they become better understood by reference to the following detailed description. The elements of the drawings are not necessarily to scale relative to each other. Like reference numerals designate corresponding similar parts.

FIG. 1 illustrates a simplified block diagram of an echo compensation apparatus according to a first embodiment of the invention.

FIG. 2 illustrates a simplified block diagram of an echo compensation apparatus according to a second embodiment of the invention.

### DETAILED DESCRIPTION

In the following Detailed Description, reference is made to the accompanying drawings, which form a part hereof, and in which is shown by way of illustration specific embodiments in which the invention may be practiced. In this regard, directional terminology, such as “top,” “bottom,” “front,” “back,” “leading,” “trailing,” etc., is used with reference to the orientation of the Figure(s) being described. Because components of embodiments of the present invention can be positioned in a number of different orientations, the directional terminology is used for purposes of illustration and is in no way limiting. It is to be understood that other embodiments may be utilized and structural or logical changes may be made without departing from the scope of the present invention. The following detailed description, therefore, is not to be taken in a limiting sense, and the scope of the present invention is defined by the appended claims.

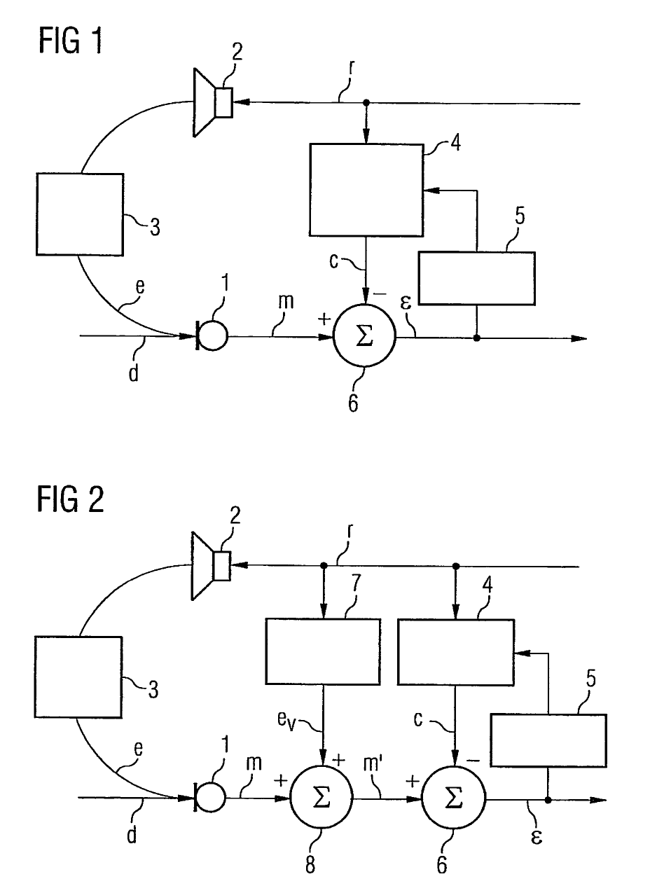

The embodiment illustrated in FIG. 1 is an apparatus for acoustic echo compensation as can be used, for example, for hands-free applications. An acoustic transmitted signal r is supplied to a loudspeaker for reproduction while an acoustic received signal d is acquired by a microphone 1. The received signal d is impaired by crosstalk from the transmitted signal r, as is indicated schematically in FIG. 1 by an echo path 3 via which the received signal d is affected by an echo e. This has the result that the signal m acquired and emitted by the microphone does not correspond to the pure received signal d, but to the sum of the received signal d and the echo e, i.e.:
m=d+e. (1)

The signal m is therefore referred to below as the echo-affected received signal.

The objective of echo compensation is to eliminate the echo e in the echo-affected received signal m. For this purpose, a compensation signal c is generated from the transmitted signal r by means of an adaptive filter 4 and subtracted from the echo-affected received signal m via an adder 6. In the ideal case, the compensation signal c should correspond to the echo e, so that the output signal ε of the adder 6 corresponds to the pure received signal d, i.e. only the received signal d remains after compensation.

In one embodiment, the adaptive filter 4, which may be, for example, an FIR filter, simulates as optimally as possible the total echo path 3, including the characteristic of the loudspeaker 2, the acoustic environment and the microphone 1. The coefficients hⱼ of the adaptive filter 4 are modified in order to minimize the energy of the residual echo, which is defined by the difference of the echo e and the compensation signal c. In this operation, the following algorithm, represented in normalized form, is frequently used in order both to ensure sufficient stability and at the same time to achieve a convergence speed independent of absolute signal values and therefore of scaling:

$${h}_{j}^{i + 1} = {h}_{j}^{i} + \frac{2 {αɛ}_{i} {r}_{i - j} {h}_{j}^{i}}{‖ r ‖ i2} . \qquad ( 2 )$$

In this equation, i denotes the iteration index and j the filter coefficient index. ∥r∥ᵢ² denotes the total energy (sum of the squares) of the scanning values of the transmitted or reference signal r. α denotes a step size factor of the adaptive filter 4 which is used for adaptation of the filter coefficients, where:
0<α<1. (3)

In one embodiment illustrated in FIG. 1 adjustment of the filter coefficients of the adaptive filter 4 is effected via a control unit 5 that selects the step size factor α in dependence on the correlation between the echo-affected received signal m and the compensation signal c:
α=δ+α₀ρ_{m,c}. (4)

Here, α₀(0<α₀<1) denotes a factor for undisturbed adaptation while ρ_{m,c} (0≦ρ_{m,c}≦1) denotes the zero-th cross-correlation coefficient between the echo-affected received signal m and the compensation signal c. Negative values of ρ_{m,c} are set to 0.δ(δ>0) represents a small constant (e.g. δ=0.01) which contributes to the permanent maintenance of α>0.

The embodiment of the present invention is based on the following reasoning:

If d=0, that is, if m=e, and if the adaptive filter 4 is in a perfectly converged state, that is, if c=e, then ρ_{m,c}=ρ_{e,e}=1, whereby undisturbed adaptation is correctly indicated.

If d=0 and the adaptive filter 4 has not yet converged, then initially ρ_{m,c}<1. Every adaptation step brings ρ_{m,c} closer to 1, since with undisturbed adaptation a positive back-coupling exists between the step size factor α and the correlation. The larger the step size factor α is, the more quickly the adaptive filter 4 can simulate the echo path 3, and the higher the correlation between the echo-affected received signal m (which, because d=O, corresponds to the echo e) and the compensation signal c (which corresponds to an estimation of the echo e) therefore becomes, whereby the step size factor α is further increased.

If, however, d≠0, then ρ_{m,c}<1, and ρ_{m,c} remains small independently of the convergence of the adaptive filter 4, provided d is large.

In the case of a small echo e with the above-described approach, however, undefined adaptation behavior can occur, which behavior will be explained briefly below.

The correlation between the echo-affected received signal m and the compensation signal c can be expressed as follows in the form of inner products and normalisations:

$${ρ}_{m , c} = \frac{( m , c )}{‖ m ‖ ‖ c ‖} . \qquad ( 5 )$$

It can be seen from equation (5) that for c=0 ρ_{m,c} becomes undefined. By inserting a correction term s>0 with

$${ρ}_{m , c} = \frac{( m , c )}{s + ‖ m ‖ ‖ c ‖} \qquad ( 6 )$$

ρ_{m,c} could be approximated in these cases to 0, although adaptation would thereby be practically suppressed. Because a small compensation signal c is a necessary consequence of a small echo e, adaptation with the above-described approach would become undefined with a small echo, while adaptation according to equation (6) would be very slow.

To solve this problem, in the embodiment illustrated in FIG. 2, a small compensation signal c is avoided by introducing a virtual echo path. In the following explanation of the embodiment illustrated in FIG. 2, for simplicity only the differences from FIG. 1 will be discussed, so that the description relating to FIG. 1 can be referred to for completeness.

The virtual echo path inserted between the transmitted signal path and the received signal path in the embodiment illustrated in FIG. 2 includes a digital filter 7. In one embodiment, digital filter 7 is in the form of an FIR filter with constant coefficients. The length of the filter 7 is shorter than or equal to the length of the adaptive filter 4. The coefficients of the filter 7 can have any relatively small values.

Before adaptation, the filter coefficients of the adaptive filter 4 are not initialized with 0, as with conventional LMS (“Least Mean Square”) filter algorithms, but with the coefficients of the filter 7 of the virtual echo path, in order to be able to begin the adaptation with a system error which is not impaired by the virtual echo eᵥ generated by the filter 7 of the virtual echo path. As can be seen from FIG. 2, the virtual echo eᵥ generated by the virtual echo path is combined with, in particular added to, the echo-affected received signal m with the aid of an adder 8, before the compensation signal c is subtracted from the resulting processed echo-affected received signal m′ with the aid of the adder 6.

The step size factor α is now calculated by the control unit 5 according to
α=δ+α₀ρ_{m′,c}, (7)
where
m′=m+eᵥ. (8)

When ρ_{m′,c} is expressed in the form of inner products and normalizations, then:

$${ρ}_{{m}^{′} , c} = \frac{( d + e + {e}_{v} , c )}{‖ d + e + {e}_{v} ‖ ‖ c ‖} . \qquad ( 9 )$$

If the real echo e disappears, that is, if e=0, two cases can be distinguished.

For a small received signal d (d<<eᵥ) it follows that:

$${ρ}_{{m}^{′} , c} \approx \frac{( {e}_{v} , c )}{‖ {e}_{v} ‖ ‖ c ‖} . \qquad ( 10 )$$

In this case ρ_{m′,c} therefore approaches the value 1, if the compensation signal c approaches the virtual echo eᵥ.

For a large received signal d (d>>eᵥ) it follows that:

$${ρ}_{{m}^{′} , c} \approx \frac{( d , c )}{‖ d ‖ ‖ c ‖} . \qquad ( 11 )$$

This means that ρ_{m′,c} always assumes small values if the pure received signal d which disturbs adaptation has no correlation to the echo (including the virtual echo) or to the corresponding compensation signal c, which corresponds to an estimation of the echo. Because the virtual echo path with the filter 7 prevents the compensation signal c from assuming the value 0, ρ_{m′,c} is always defined, which in turn has the result that the adaptation behavior of the adaptive filter 4 is always defined.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein. Therefore, it is intended that this invention be limited only by the claims and the equivalents thereof.

1. A method for echo compensation comprising:
generating a compensation signal in dependence on a transmitted signal with the aid of adaptive filter means;
combining the compensation signal with an echo-affected received signal, which is affected by an echo produced by the transmitted signal, in order to obtain the received signal without echo; and
adapting the adaptive filter means in dependence on a correlation between the echo-affected received signal and the compensation signal.

2. The method of claim 1, wherein the adaptive filter means includes at least one digital FIR filter.

3. The method of claim 1, wherein the compensation signal is subtracted from the echo-affected received signal in order to obtain the received signal without echo.

4. The method of claim 1, wherein a step size factor α is determined for the adjustment of coefficients of the adaptive filter means according to α=δ+α₀ρ_{m,c} where δ and α₀ are constants, while ρ_{m,c} denotes the zero-th cross-correlation coefficient between the echo-affected received signal and the compensation signal.

5. The method of claim 4, wherein δ>0, 0<α₀<1 and 0≦ρ_{m,c}≦1, negative values of ρ_{m,c} being set to 0.

6. The method of claim 1, wherein a virtual echo signal is generated with the aid of further filter means in dependence on the transmitted signal, wherein the virtual echo signal is combined with the echo-affected received signal before the resulting echo-affected received signal prepared in this way is in turn combined with the compensation signal.

7. The method of claim 6, wherein the adaptive filter means is adapted in dependence on a correlation between the echo-affected received signal prepared with the aid of the virtual echo signal and the compensation signal.

8. The method of claim 6, wherein the further filter means includes at least one digital FIR filter.

9. The method of claim 6, wherein the further filter means has fixed coefficients.

10. The method of claim 6, wherein the length of the further filter means is shorter than or equal to the length of the adaptive filter means.

11. The method of claim 6, wherein coefficients of the adaptive filter means are initialized with coefficients of the further filter means.

12. The method of claim 6, wherein a step size factor α is determined for the adjustment of coefficients of the adaptive filter means according to α=δ+α₀ρ_{m′,c}, where δ and α₀ are constants, while ρ_{m′,c} denotes the zero-th cross-correlation coefficient between the echo-affected received signal processed with the virtual echo signal and the compensation signal.

13. The method of claim 12, wherein δ>0, 0<α₀<1 and 0≦ρ_{m′,c}≦1, negative values of ρ_{m′,c} being set to 0.

14. The method of claim 6, wherein the virtual echo signal is added to the echo-affected received signal in order to obtain the processed echo-affected received signal.

15. An apparatus for echo compensation, comprising:
adaptive filter means for generating a compensation signal in dependence on a transmitted signal;
combination means for combining the compensation signal with an echo affected received signal, which is affected by an echo produced by the transmitted signal, in order to obtain the received signal without echo; and
control means configured such that they adapt the adaptive filter means in dependence on a correlation between the echo-affected received signal and the compensation signal.

16. The apparatus of claim 15, wherein the adaptive filter means include at least one digital FIR filter.

17. The apparatus of claim 15, wherein the combination means are configured such that they subtract the compensation signal from the echo affected received signal in order to obtain the received signal without echo.

18. The apparatus of claim 15, wherein the control means are configured such that they determine a step size factor α for the adjustment of coefficients of the adaptive filter means according to α=δ+α₀ρ_{m,c} where δ and α₀ are constants, while ρ_{m,c} denotes the zero-th cross-correlation coefficient between the echo-affected received signal and the compensation signal.

19. The apparatus of claim 18, wherein δ>0, 0<α₀<1 and 0≦ρ_{m,c}≦1, the control means setting negative values of ρ_{m,c} to 0.

20. The apparatus of claim 15, wherein further filter means are provided to generate a virtual echo signal in dependence on the transmitted signal and in that further combination means are provided for combining the virtual echo signal with the echo-affected received signal before the resulting echo-affected received signal prepared in this way is supplied to the combination means for combination with the compensation signal.

21. The apparatus of to claim 20, wherein the control means are configured such that they adapt the adaptive filter means in dependence on a correlation between the echo-affected received signal prepared with the aid of the virtual echo signal and the compensation signal.

22. The apparatus of claim 20, wherein the further filter means include at least one digital FIR filter.

23. The apparatus of claim 20, wherein the further filter means have fixed coefficients.

24. The apparatus of claim 20, wherein the length of the further filter means is less than or equal to the length of the adaptive filter means.

25. The apparatus of claim 20, wherein coefficients of the adaptive filter means are initialized with coefficients of the further filter means.

26. The apparatus of claim 20, wherein the control means are so configured that they determine a step size factor α for the adjustment of coefficients of the =adaptive filter means according to α=δ+α₀ρ_{m′,c}, where δ and α₀ are constants, while ρ_{m′,c} denotes the zero-th cross-correlation coefficient between the echo-affected received signal processed with the virtual echo signal and the compensation signal.

27. The apparatus of claim 26, wherein δ>0, 0<α₀<1 and 0≦ρ_{m′,c}≦1, the control means setting negative values of ρ_{m′,c} to 0.

28. The apparatus of claim 20, wherein the further combination means are configured such that they add the virtual echo signal to the echo-affected received signal in order to obtain the processed echo-affected received signal.

29. The apparatus of claim 15 configured for use with full-band echo compensation.

30. The apparatus of claim 15 configured for use with sub-band echo compensation.

31. The apparatus according to claim 30, wherein for each sub-band an individual step size factor is determined for adapting the adaptive filter means in dependence on the correlation between the echo-affected received signal and the compensation signal.

32. The apparatus according to claim 30, wherein for all sub-bands a common step size factor is determined for adapting the adaptive filter means in dependence on the correlation between the echo-affected received signal and the compensation signal.
